(19) United States
(12) Patent Application Publication
(10) Pub. No.: US 2026/0342410 A1
(43) Pub. Date: Oct. 29, 2026

(54) LIFE CYCLE MANAGEMENT FOR BEAMBOOK DESIGN

(71) Applicant: Samsung Electronics Co., Ltd., Suwon-si (KR)

(72) Inventors: Javad Abdoli, Plano, TX (US); Mustafa Furkan Ozkoc, The Colony, TX (US); Young Han Nam, Plano, TX (US); Chaehee Lim, Seoul (KR); Namkoo Kang, Seoul (KR)

(21) Appl. No.: 19/578,700

(22) Filed: Mar. 25, 2026

Related U.S. Application Data
(60) Provisional application No. 63/796,197, filed on Apr. 28, 2025.

(51) Int. Cl. H04B 7/06

(52) U.S. Cl. CPC H04B 7/0639

(57) ABSTRACT

Methods and apparatuses for a life cycle management for a beambook design in wireless communication systems. The method of a base station comprises: configuring a BB management entity to monitor performance of a BB configured to an AU; identifying a condition to trigger an AU-specific BB optimization operation for activating a new BB associated with the AU; identifying, based on the condition, a measurement aggregation time; identifying, based on the measurement aggregation time, a set of measurement tables each of which includes a set of beam identification (IDs) and a number of beam usage counts; and activating, based on the set of measurement table, the new BB associated with the AU.

### CROSS-REFERENCE TO RELATED APPLICATIONS AND CLAIM OF PRIORITY

The present application claims priority to U.S. Provisional Patent Application No. 63/796,197, filed on Apr. 28, 2025. The contents of the above-identified patent documents are incorporated herein by reference.

### TECHNICAL FIELD

The present disclosure relates generally to wireless communication systems and, more specifically, the present disclosure relates to a life cycle management for a beambook design in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a life cycle management for a beambook design in wireless communication systems.

In one embodiment, a base station (BS) in a wireless communication system is provided. The BS comprises a transceiver and a processor operably coupled to the transceiver, the processor configured to: configure a beambook (BB) management entity to monitor performance of a BB configured to an access unit (AU), identify a condition to trigger an AU-specific BB optimization operation for activating a new BB associated with the AU, identify, based on the condition, a measurement aggregation time, identify, based on the measurement aggregation time, a set of measurement tables each of which includes a set of beam identification (IDs) and a number of beam usage counts, and activate, based on the set of measurement table, the new BB associated with the AU.

In another embodiment, a method a BS in a wireless communication system is provided. The method comprises: configuring a BB management entity to monitor performance of a BB configured to an AU; identifying a condition to trigger an AU-specific BB optimization operation for activating a new BB associated with the AU; identifying, based on the condition, a measurement aggregation time; identifying, based on the measurement aggregation time, a set of measurement tables each of which includes a set of beam IDs and a number of beam usage counts; and activating, based on the set of measurement table, the new BB associated with the AU.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of high-level architecture of LCM for a cell-specific BB design according to various embodiments of the present disclosure;

FIG. 8 illustrates an example of LCM for cell-specific BB design according to various embodiments of the present disclosure;

FIG. 9 illustrates an example of BB database at OAM file server according to various embodiments of the present disclosure;

FIG. 10 illustrates an example of mapping between BBs of the OAM BB database and different AUs according to various embodiments of the present disclosure;

FIG. 11A illustrates an example of overall time-evolution of life cycle management of cell-specific beambook design according to various embodiments of the present disclosure;

FIG. 11B illustrates another example of overall time-evolution of life cycle management of cell-specific beambook design according to various embodiments of the present disclosure;

FIG. 12A illustrates an example of OAM measurement aggregation (Option 1) according to various embodiments of the present disclosure;

FIG. 12B illustrates another example of OAM measurement aggregation (Option 1) according to various embodiments of the present disclosure;

FIG. 13A illustrates an example of OAM measurement aggregation (Option 2) according to various embodiments of the present disclosure;

FIG. 13B illustrates another example of OAM measurement aggregation (Option 2) according to various embodiments of the present disclosure;

FIG. 14 illustrates an example of OAM measurement database (Option 1) according to various embodiments of the present disclosure;

FIG. 15 illustrates an example of OAM measurement database (Option 2) according to various embodiments of the present disclosure;

FIG. 16 illustrates an example of ping pong event in AU-specific BB performance monitoring according to various embodiments of the present disclosure;

FIG. 17 illustrates an example of BB KPI storage and monitoring at OAM according to various embodiments of the present disclosure;

FIG. 18A illustrates an example of BB activation BBᵢ₍ₙ₎→BB_{L+1} according to various embodiments of the present disclosure;

FIG. 18B illustrates an example of BB activation BBᵢ₍ₙ₎→BB_{L+1} according to various embodiments of the present disclosure;

FIG. 19A illustrates an example of single-step BB roll-back BBᵢ₍ₙ₎→BBᵢ₍ₙ₋₁₎ according to various embodiments of the present disclosure;

FIG. 19B illustrates an example of single-step BB roll-back BBᵢ₍ₙ₎→BBᵢ₍ₙ₋₁₎ according to various embodiments of the present disclosure;

FIG. 20 illustrates a flowchart of method for AU-specific BB performance monitoring N_{R}≥1 according to various embodiments of the present disclosure;

FIG. 21 illustrates a flowchart of method for AU-specific BB performance monitoring N_{R}=0 according to various embodiments of the present disclosure; and

FIG. 22 illustrates a flowchart of a method of a base station for a life cycle management for a beambook design according to various embodiments of the present disclosure.

### DETAILED DESCRIPTION

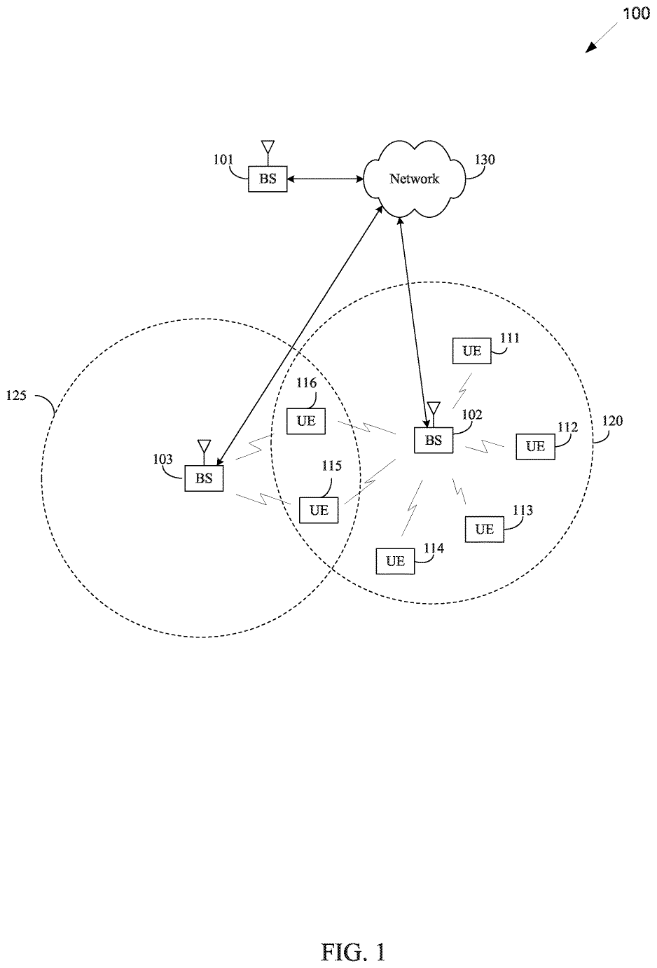

FIG. 1 through FIG. 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a life cycle management for a beambook design in wireless communication systems, at a gNB 101-103, in wireless communication systems. In certain embodiments, and one or more of the gNBs 101-103 includes circuitry, programing, or a combination thereof, to support a life cycle management for a beambook design in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

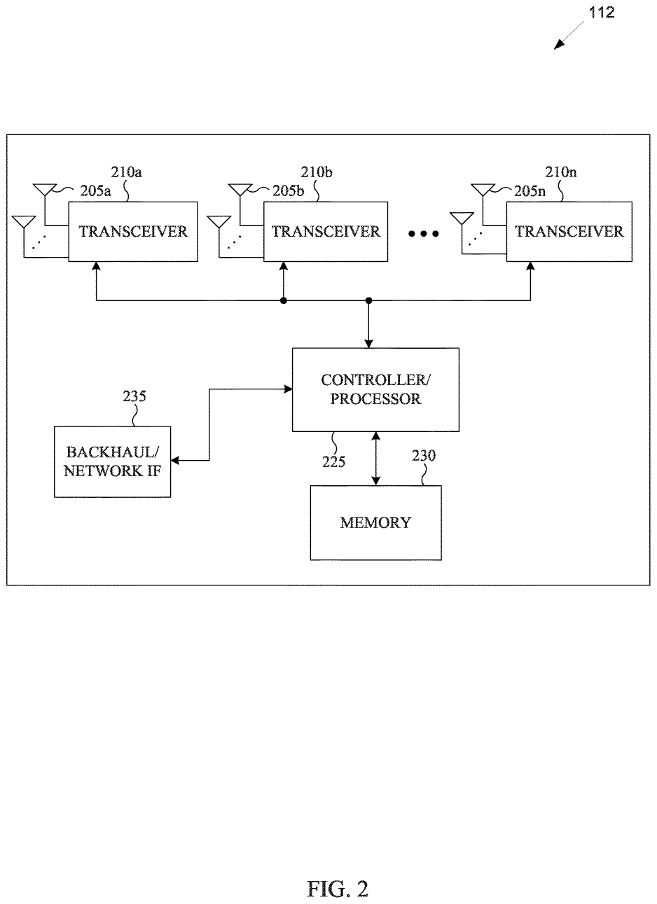

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a life cycle management for a beambook design in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

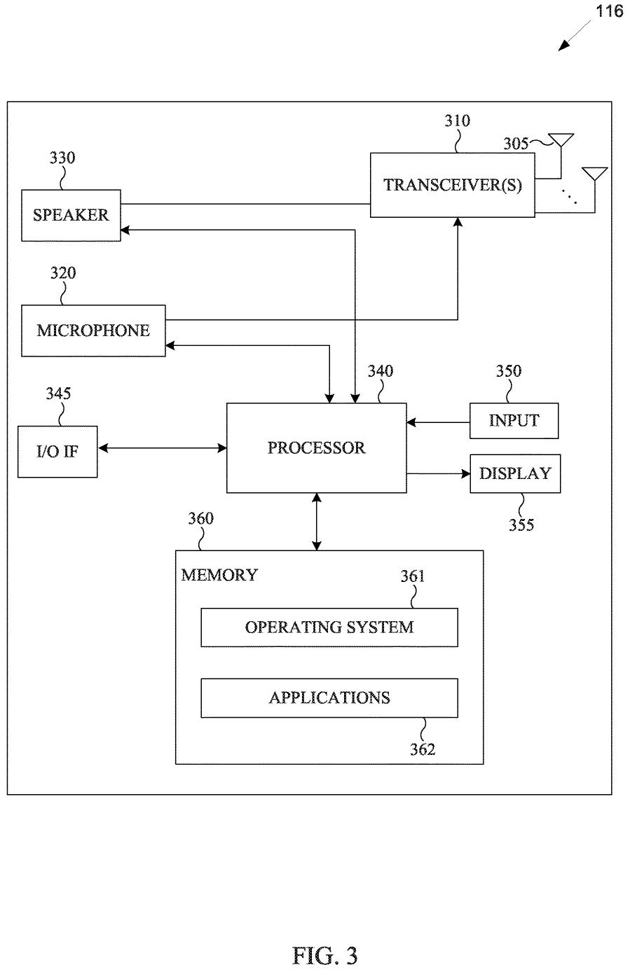

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a life cycle management for a beambook design in wireless communication systems, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

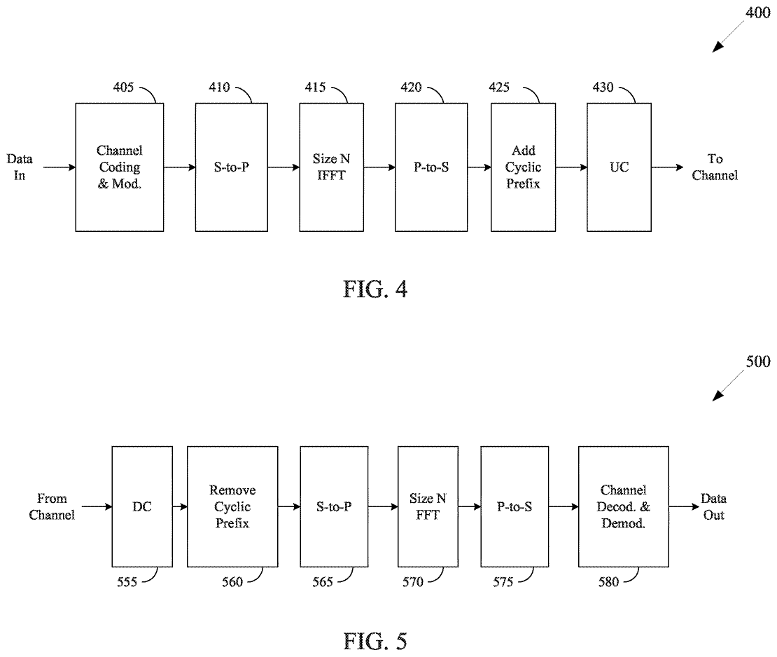

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency and removes cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architecture can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

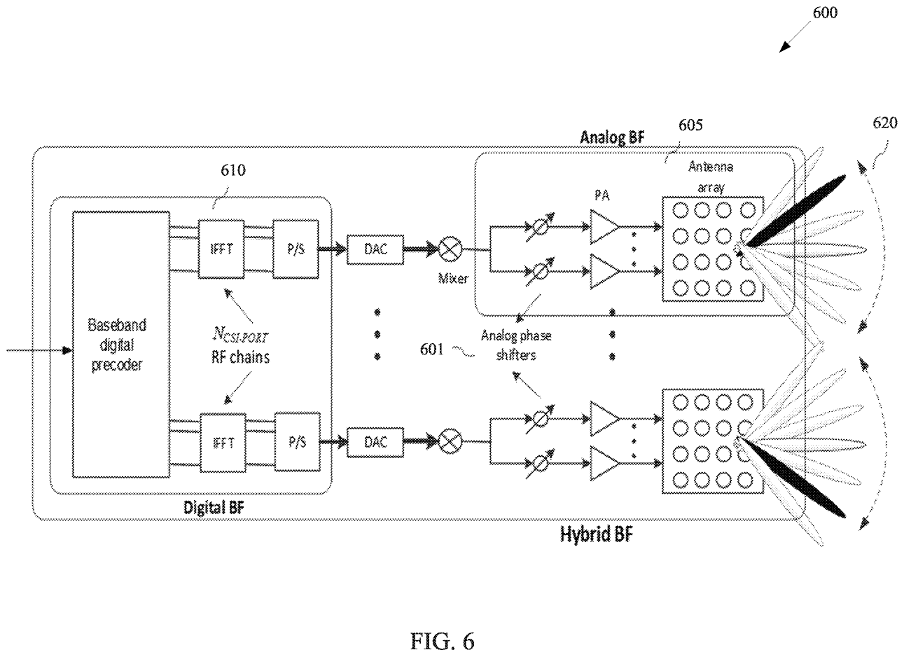

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

Analog beamforming in millimeter wave base stations relies on pre-designed beambooks (BBs) to achieve efficient signal transmission. While larger BBs enhance beamforming gains per link, they also introduce significant beam management overhead, complicating system operations. Additionally, an increased number of beams can lead to higher beam change frequencies for a mobile user equipment (UE), potentially degrading beam tracking accuracy. Consequently, improving total cell and per-UE throughput involves balancing the size of BBs to achieve high BF gains with a reduced overhead and maintaining high beam tracking precision.

BB designs often prioritize uniform coverage across the angular coverage range, even though UE distribution is rarely uniform. Environmental factors such as pedestrian paths, bus stops, or varying shop popularity lead to UEs clustering in specific areas. This discrepancy between uniform beam coverage and non-uniform UE distribution results in suboptimal average BF gains. Therefore, a cell specific BB tailored to UE density, where more beams are directed towards high density UE areas, can improve the average BF gain. Performance of the cell specific BB depends on how well the BB is adapted to changes in cell characteristics, including UE density distribution. Therefore, a life cycle management (LCM) may be performed to ensure the cell specific BBs that are designed and updated properly in a timely manner such that a desired BF performance in the cell is maintained despite potential changes in the cell characteristics.

In some embodiments, the present disclosure can include (i.e., but is not limited to): (i) configuring a BB management entity to monitor BB performance of a BB of an access unit (AU) and to trigger AU-specific BB re-optimization at a BB design entity when one or more specified conditions of a new BB activation for the AU are met; (ii) maintaining a set of measurement tables for each AU based on a measurement aggregation time, wherein each measurement table includes at least a set of beam identifications (IDs) and their corresponding beam usage counts; and (iii) performing an action, at each AU-specific BB performance monitoring, if the one or more specified conditions of the action are met, out of a set of actions including at least one of: (1) no BB change, (2) design and activate a new AU-specific BB, (3) roll back to a previously activated AU-specific BB, or (4) roll back to an initial BB.

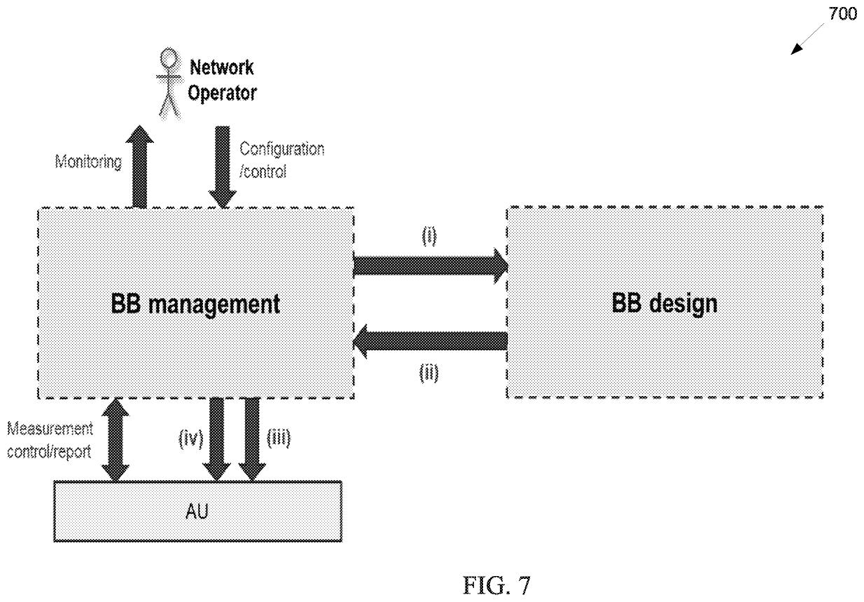

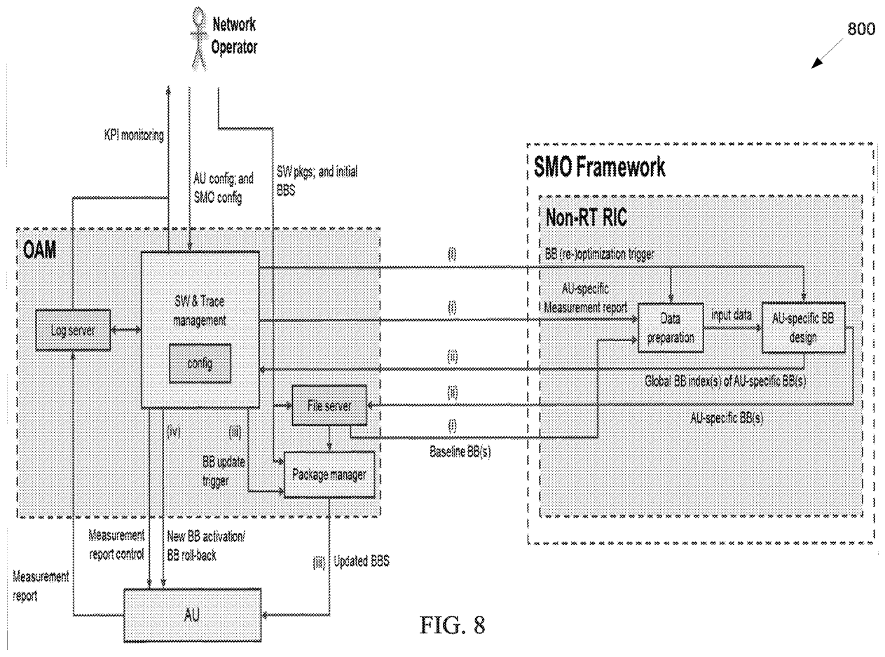

FIG. 7 illustrates an example of a high-level architecture of LCM for a cell-specific BB design 700 according to various embodiments of the present disclosure. An embodiment of the high-level architecture of LCM a for cell-specific BB design 700 shown in FIG. 7 is for illustration only.

In one embodiment, a life cycle management of cell-specific beambook design is provided. A BB management entity monitors BB performance of a BB of an AU and when conditions of new BB activation for the AU are met, the BB management entity triggers AU-specific BB (re-)optimization at a BB design entity. Additionally, the BB management entity transfers a baseline BB and AU-specific measurement reports to the BB design entity. These actions are collectively named “BB optimization/re-optimization trigger” and marked as (i) in FIG. 7.

In some embodiments, the disclosed technology can perform the following operations. In one example, a BB database is updated: the BB design entity transfers newly designed BB(s) to a BB database upon generation of the new BBs. Additionally, global BB index(es) of the new BB(s) are transferred to the BB management entity. These actions are illustrated in FIG. 7 (e.g., as (ii) in FIG. 7).

In one example, AU-specific BB set (BBS) is updated: within the BB management entity, a package manager constructs an updated BBS and delivers the updated BBS to the AU. These actions are illustrated in FIG. 7 (e.g., as (iii) in FIG. 7).

In one example, AU-specific BB control is performed: the BB management entity activates a specific BB within the updated BBS of the AU. This action is illustrated in FIG. 7 (e.g., as (iv) in FIG. 7).

In an example, BB management entity resides in operations, administration, and maintenance (OAM). In another example, the BB management entity resides in non-real-time radio intelligent controller (non-RT RIC). In yet another example, the BB management entity is an rApp in the non-RT RIC.

In an example of this embodiment, the BB design entity resides in non-RT RIC. In a particular implementation of this example, the BB design entity is an rApp in the non-RT RIC.

In one embodiment, overall architecture for LCM of cell-specific BB design which includes the actions (i)-(iv), as illustrated in FIG. 7, described above and other relevant actions are provided here. In particular, the overall LCM operates according to the following steps, as illustrated in FIG. 8.

FIG. 8 illustrates an example of LCM for cell-specific BB design 800 according to various embodiments of the present disclosure. An embodiment of the LCM for cell-specific BB design 800 shown in FIG. 8 is for illustration only.

In one embodiment of step 1 (e.g., initial configuration), a network operator of a cellular communication network performs the following actions: (i) a network operator configures an AU and a service management and orchestration (SMO) entity via software (SW) and trace management functionality of an OAM; (ii) a network operator uploads software package (SW pkg.) and an initial beambook set (BBS) to a file server which resides within the OAM; (iii) a network operator instructs package manager to deliver the initial BBS to the AU; and (iv) SW and trace management activates a BB from the initial BBS for the AU.

In one embodiment of step 2 (e.g., beam management at AU), an AU operates using the activated BB. In particular, the AU performs beam management (BM) using the activated BB. As part of the BM procedure, (i) the AU transmits downlink (DL) reference signals (RS) using different beams within the activated BB and (ii) each UE within a cell served by the AU performs measurements on the DL RSs transmitted by the AU. The UE sends measurement results to the AU as part of a measurement report. Examples of measurement quantities included in a UE's measurement report are as follows: (i) an ID of a reference signal (RS) on which a beam with largest measured reference signal received power (RSRP) is received and/or its corresponding RSRP and (ii) optionally, an ID of an RS on which a beam with second largest RSRP is received and/or its corresponding RSRP.

In one embodiment of step 3 (e.g., measurement aggregation at AU), the AU aggregates the received measurement reports from all UEs within its serving cell and reports the aggregated measurements to the OAM.

In one embodiment of step 4 (e.g., measurement aggregation at OAM), OAM stores and aggregates the received measurement reports of the AU (AU-specific measurement reports) in its log server.

In one embodiment of step 5 (e.g., BB performance monitoring at OAM), OAM monitors performance of the activated BB of the AU based on the aggregated measurements of the AU and a key performance indicator (KPI) or set of KPIs. The results of the BB performance monitoring are also made available to the network operator via an interface between the OAM and the network operator. The details of the BB performance monitoring, including the condition(s) for “new BB activation” and “BB roll-back” are provided mentioned embodiments of the present disclosure.

In one example, if condition(s) for none of “new BB activation” or “BB roll-back” is met, the LCM goes back to and follows—Error! Reference source not found. as mentioned in the present disclosure. In one example, if condition(s) for “new BB activation” is/are met, LCM proceeds to Error! Reference source not found. below. In one example, if condition(s) for “BB roll-back” is met, LCM proceeds to Error! Reference source not found. below.

In one embodiment of step 6 (e.g., BB optimization/re-optimization trigger at OAM), the OAM triggers BB optimization/re-optimization procedure. In particular, the OAM performs the following actions which are collectively marked as (i) in FIG. 8: (i) SW and trace management triggers AU-specific BB optimization at non-real-time radio intelligent controller (non-RT RIC); (ii) SW and trace management instructs that a baseline BB or a set of baseline BBs is transferred from OAM's file server to non-RT RIC. In an example, the baseline BB/set of baseline BBs is/are the latest activated BB/set of BBs of the AU. In an example, non-RT RIC uses the baseline BB(s) as an input based on which it optimizes and generates new BB(s); and (iii) SW and trace management transfers the AU-specific measurement reports to the non-RT RIC.

In one embodiment of step 7, (e.g., BB optimization/re-optimization at non-RT RIC), non-RT RIC performs BB optimization and generates a new BB or set of BBs. In particular, non-RT RIC performs the following actions: (i) a data preparation entity within the non-RT RIC prepares an input data for a BB design entity within the non-RT RIC using the AU-specific measurement data and the baseline BB(s) received from the OAM; and (ii) the BB design entity executes a BB design/optimization algorithm using the input data and generates a new BB/set of BBs. In an example, the new BB/set of BBs is/are AU-specific. In another example, the new BB/set of BBs is/are specific to a set of AUs, a.k.a. AU cluster. AU clustering is a set of one or more AUs with similar AU attributes. Examples of AU attribute(s) of an AU are one or more of the following: (i) size of a cell served by the AU; (ii) load/traffic characteristics of a cell served by the AU; and/or (iii) angular scan range of the AU.

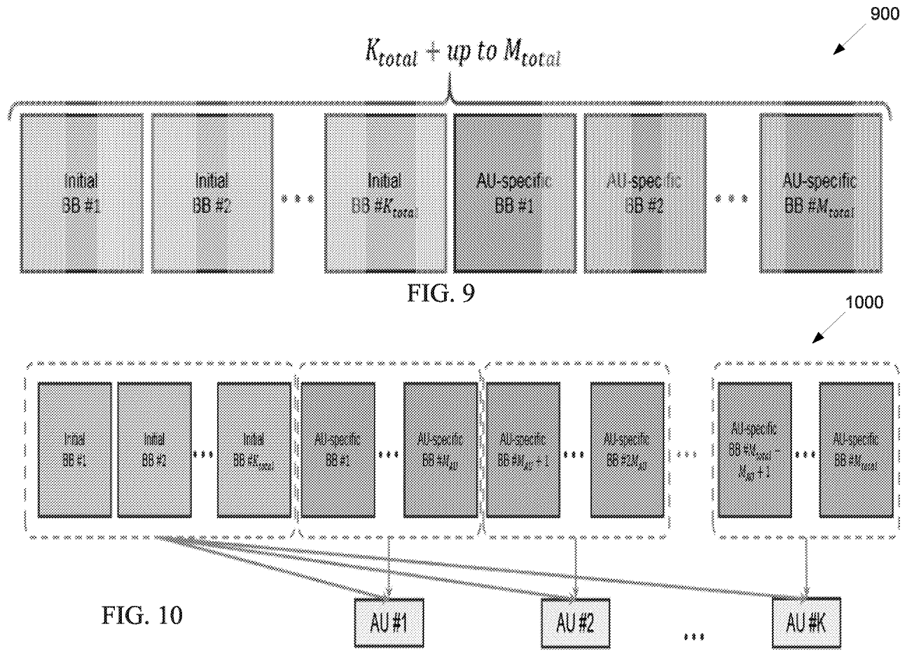

FIG. 9 illustrates an example of BB database at OAM file server 900 according to various embodiments of the present disclosure. An embodiment of the BB database at OAM file server 900 shown in FIG. 9 is for illustration only.

In one embodiment of step 8 (e.g., BB database update), the non-RT RIC performs the following actions, as illustrated in (ii) of FIG. 8: (i) the non-RT RIC transfers newly designed BB(s) to a BB database in the file server of the OAM upon generation of the new BBs. It may be performed that sufficient number of oldest AU-specific BBs are removed from the BB database such that the total number of BBs, including the new BB(s), in the BB database does not exceed database size of Kₜₒₜₐₗ+Mₜₒₜₐₗ as illustrated in FIG. 9, where Kₜₒₜₐₗ is a total number of the initial BBs and Mₜₒₜₐₗ is total number of AU-specific BBs, across all the AUs covered by an OAM. In an example of this embodiment, the initial BBs are always kept in the OAM BB database and (ii) the non-RT RIC transfers global BB index(es) of the new BB(s) to SW and trace management.

FIG. 10 illustrates an example of mapping between BBs of the OAM BB database and different AUs 1000 according to various embodiments of the present disclosure. An embodiment of the mapping between BBs of the OAM BB database and different AUs 1000 shown in FIG. 10 is for illustration only.

In one embodiment of step 9 (e.g., AU-specific BBS update), the SW and trace management instructs the package manager to construct an updated BBS and deliver the updated BBS to the AU. This is illustrated in (iii) of FIG. 10. In particular, a package manager constructs a new BBS comprising the initial BBs and MAU AU-specific BBs for the AU (or AU-cluster, if applicable), as illustrated in FIG. 8. The new BBS may also contain the previously trained AU-specific BBs. In one example, the new AU-specific BBS is transferred to the AU.

In one embodiment of step 10 (e.g., AU-specific BB control), the SW and trace management activates a specific BB within the configured BBS of the AU. This is illustrated in (iv) of FIG. 8. There are two use cases for this action as follows. The details of each use case and the corresponding actions are provided. Specifically, SW and trace management within the OAM performs one of the following actions: (i) AU-specific new BB activation: activate one of the new AU-specific BBs within the BBS when condition(s) for new BB activation is/are met. This may be triggered after AU-specific BBS update (e.g., step 9) and/or (ii) AU-specific BB roll-back: roll back to one of previously verified BBs within the BBS when condition(s) for BB rollback is/are met. The BB to roll back to can be either an initial BB or a previously verified AU-specific BB.

In one embodiment of step 11, LCM goes to step 2 and continues steps 2 to 10 as mentioned in the present disclosure.

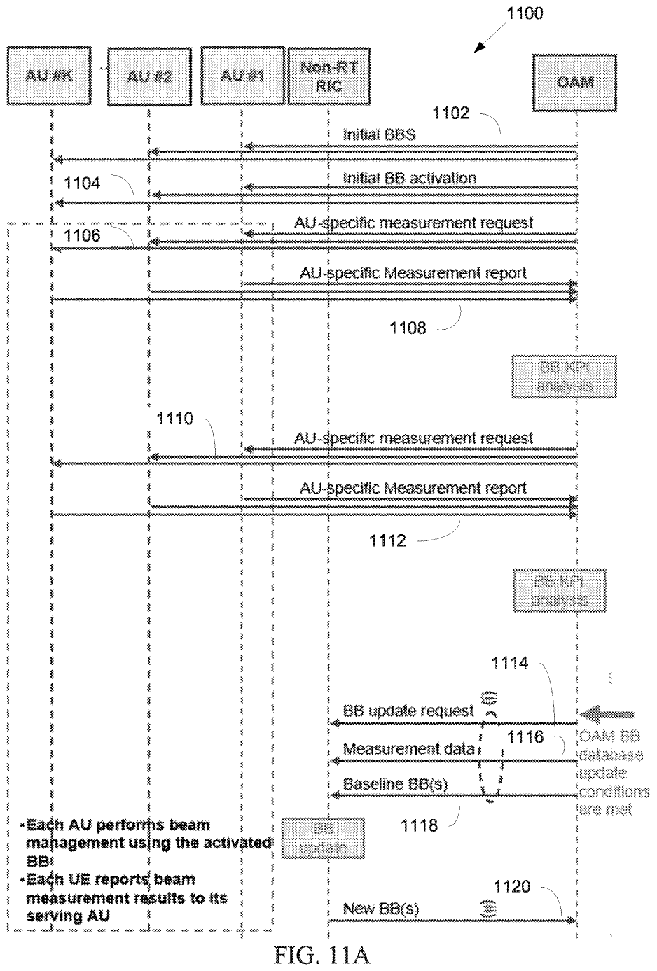

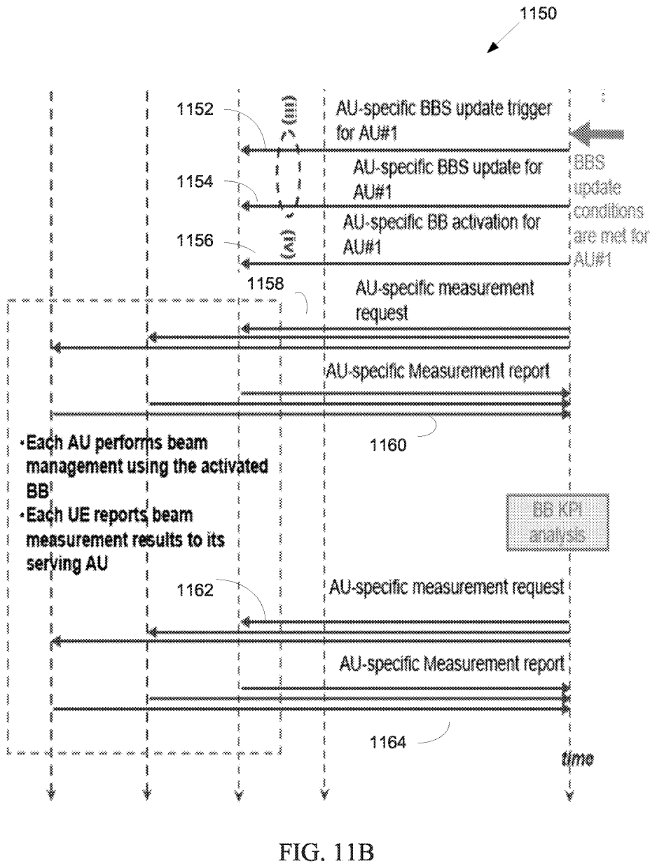

Overall time-evolution of life cycle management of cell-specific beambook design is illustrated in FIG. 11A and FIG. 11B.

FIG. 11A illustrates an example of overall time-evolution of life cycle management of cell-specific beambook design 1100 according to various embodiments of the present disclosure. An embodiment of the overall time-evolution of life cycle management of cell-specific beambook design 1100 shown in FIG. 11A is for illustration only.

FIG. 11B illustrates another example of overall time-evolution of life cycle management of cell-specific beambook design 1150 according to various embodiments of the present disclosure. An embodiment of the overall time-evolution of life cycle management of cell-specific beambook design 1150 shown in FIG. 11B is for illustration only. FIG. 11A and FIG. 11B are connected and the step 1120 in FIG. 11A is followed by the step 1152 as illustrated in FIG. 11B.

As illustrated in FIG. 11A and FIG. 11B, in step 1102 the OAM transmits an initial BBS to a set of AUs (e.g., AU #1 . . . , AU #K). In step 1104, the OAM transmits, to the set of AUs, an initial BB activation signal. In step 1106, the OAM transmits, to the set of AUs, AU-specific measurement request. In step 1108, the OAM receives AU-specific measurement report from the set of AUs. In steps 1110, the OAM transmits AU-specific measurement request to the set of AUs and receives, in step 1112, AU-specific measurement report from the set of AUs. In step 1114, the OAM transmits a BB update request to a non-RT RIC, in step 1116, the OAM transmits measurement data to the non-RT RIC, and in step 1118, the OAM transmits baseline BB(s) to the non-RT RIC, respectively. In step 1120, the OAM receives the new BB(s) from the non-RT RIC. In step 1152, 1154, and 1156, the OAM transmits AU-specific BBS update trigger for the AU #1. In step 1158, the OAM transmits AU-specific measurement report to the set of AUs and, in step 1160, the OAM receives AU-specific measurement report from the set of AUs. In step 1162, the OAM transmits AU-specific measurement request to the set of AUs and receives AU-specific measurement report from the set of AUs in step 1164.

In one embodiment, measurement database at OAM is provided. OAM maintains a set of up to M_{monitoring}≥1 measurement tables for each AU. A value of M_{monitoring}>1 may be used, e.g., for tracking time evolution of measurement tables and/or KPI averaging over multiple aggregated measurements at OAM. Each measurement table for an AU includes aggregate measurement information of multiple measurement reports received from the AU over a certain period of time, a.k.a. OAM's measurement aggregation time.

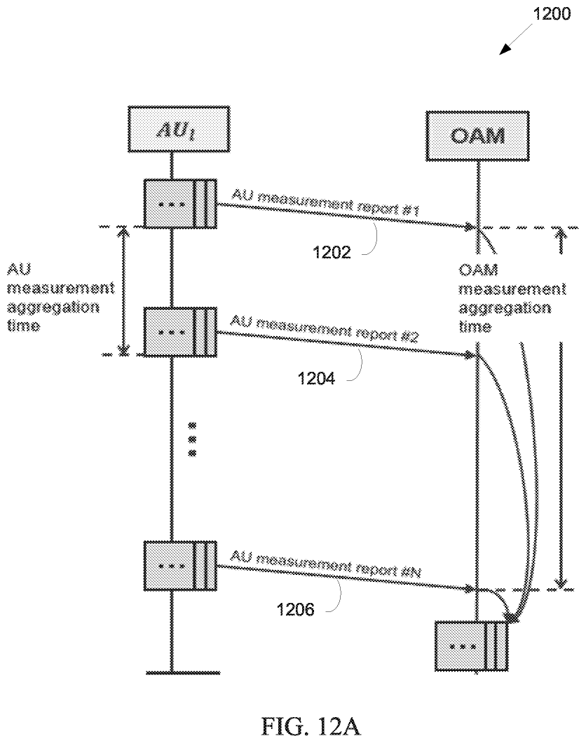

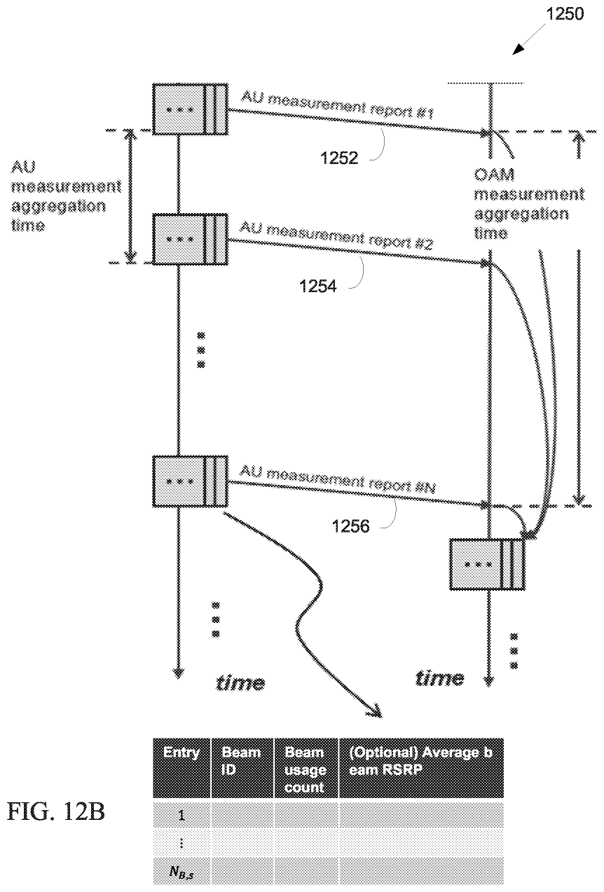

FIG. 12A illustrates an example of OAM measurement aggregation (Option 1) 2000 according to various embodiments of the present disclosure. An embodiment of the OAM measurement aggregation (Option 1) 1200 shown in FIG. 12A is for illustration only.

FIG. 12B illustrates another example of OAM measurement aggregation (Option 1) 1250 according to various embodiments of the present disclosure. An embodiment of the OAM measurement aggregation (Option 1) 1250 shown in FIG. 12B is for illustration only.

As illustrated in FIG. 12A and FIG. 12B, in steps 1202 and 1204, an AU1 sends an AU measurement report #1 and an AU measurement report #2 to OAM. In step 1206, the AU sends an AU measurement report #N to the OAM. The OAM measures and performs the OAM measurement aggregation time based on the received measurement reports from the AU. These operations of the AU are continued in steps 1252, 1254, and 1256.

In one example, illustrated as Option 1 and illustrated in FIG. 12A and FIG. 12B, each AU measurement report associated with a BB contains the following information: (i) beam ID (i): logical or physical beam ID; (ii) a beam usage count of beam #i: the number of UE measurement reports that have beam #i as their best beam; and (iii) average beam RSRP of beam #i: the beam RSRP averaged over UE measurement reports that have beam #i as their best beam. FIG. 12A and FIG. 12B are connected and the step 1206 in FIG. 12A is followed by the step 1252 as illustrated in FIG. 12B.

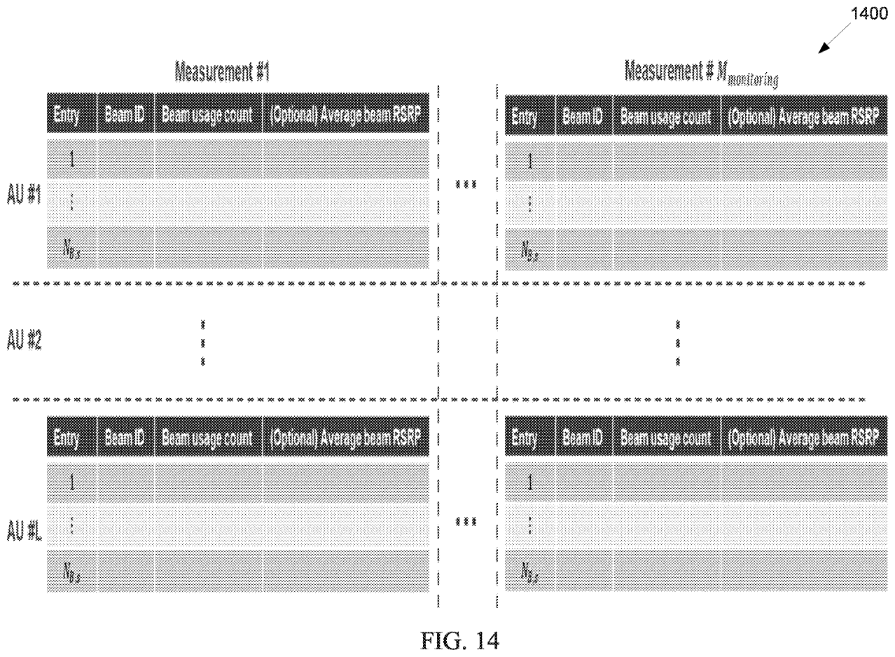

As mentioned examples of the present disclosure, a number of rows of a measurement table corresponding to an AU and a certain BB activated for the AU, e.g., BBₛ, is equal to a size of the activated BB, i.e., a number of beams in BBs, denoted as N_{B,s}, as illustrated in FIG. 14.

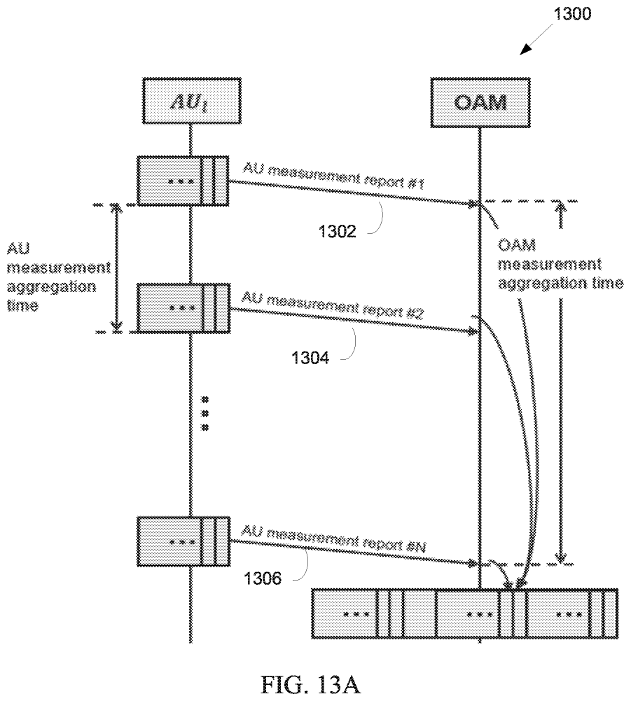

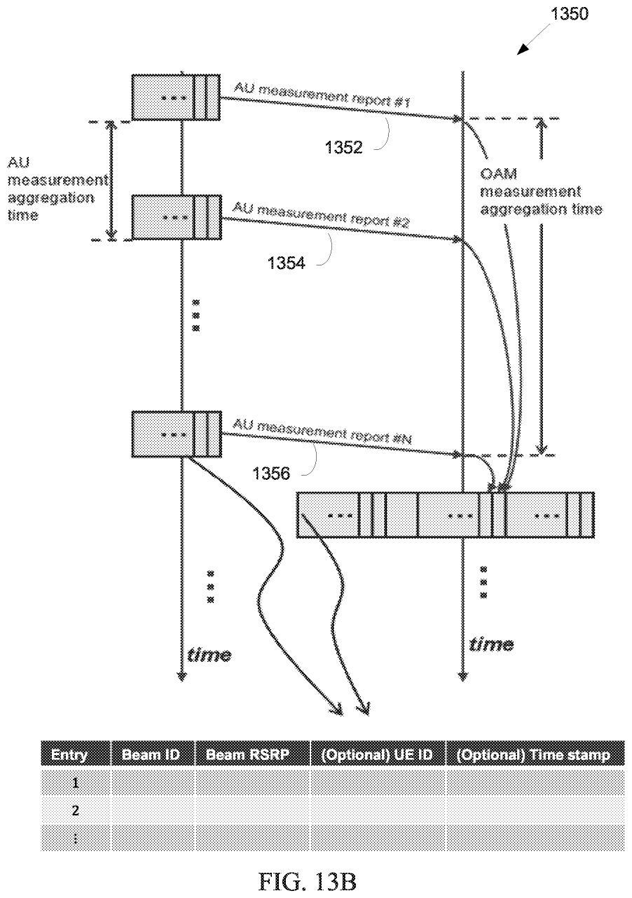

FIG. 13A illustrates an example of OAM measurement aggregation (Option 2) 1300 according to various embodiments of the present disclosure. An embodiment of the OAM measurement aggregation (Option 2) 1300 shown in FIG. 13A is for illustration only.

FIG. 13B illustrates another example of OAM measurement aggregation (Option 2) 1350 according to various embodiments of the present disclosure. An embodiment of the OAM measurement aggregation (Option 2) 1350 shown in FIG. 13B is for illustration only.

In another example of this embodiment, known as Option 2 and illustrated in FIG. 13A and FIG. 13B, each AU measurement report associated with a BB contains the following information: (i) a beam ID (i): logical or physical beam ID; (ii) beam RSRP: the (quantized) beam RSRP of beam #i; (iii) a UE ID: UE ID of the UE which has provided this particular UE measurement report; and (iv) time stamp: the time stamp of the reception of the UE measurement report at AU. FIG. 13A and FIG. 13B are connected and the step 1306 in FIG. 13A is followed by the step 1352 as illustrated in FIG. 13B.

As illustrated in FIG. 13A and FIG. 13B, in steps 1302 and 1304, an AU1 sends an AU measurement report #1 and an AU measurement report #2 to OAM. In step 1306, the AU sends an AU measurement report #N to the OAM. The OAM measures and performs the OAM measurement aggregation time based on the received measurement reports from the AU. These operations of the AU are continued in steps 1352, 1354, and 1356.

FIG. 14 illustrates an example of OAM measurement database (Option 1) 1400 according to various embodiments of the present disclosure. An embodiment of the OAM measurement database (Option 1) 1400 shown in FIG. 14 is for illustration only.

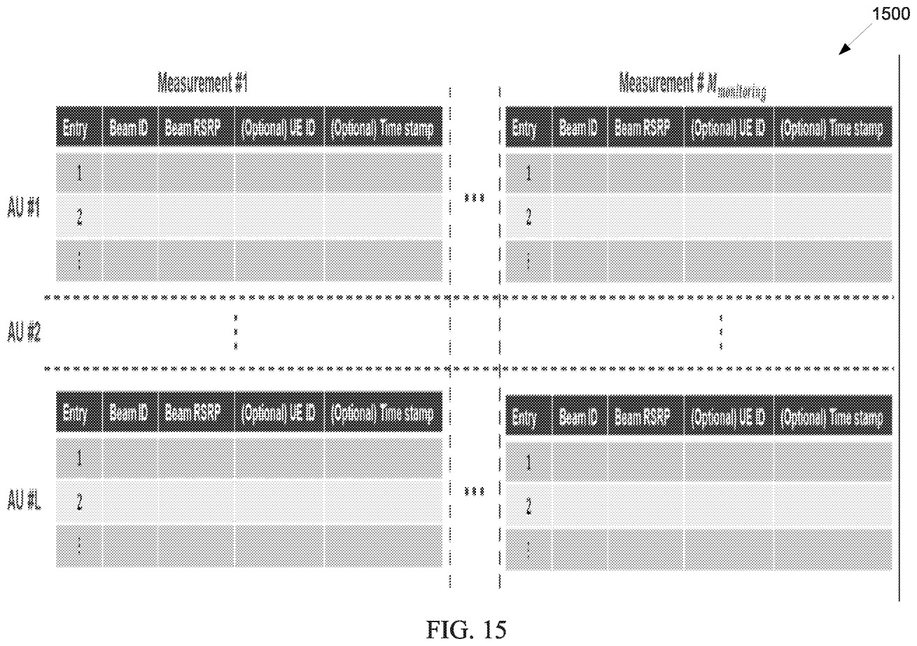

FIG. 15 illustrates an example of OAM measurement database (Option 2) 1500 according to various embodiments of the present disclosure. An embodiment of the OAM measurement database (Option 2) 1500 shown in FIG. 15 is for illustration only.

In such examples, the optional UE ID and time stamp information could be optionally used for enhancement of beam refinement scheme, e.g., for AI-based UE beam prediction. Since a measurement table in Option 2 has one entry per UE measurement report, a number of entries in a measurement table in Option 2 could be potentially much larger than in Option 1, as illustrated in FIG. 15.

In one embodiment, BB KPIs are provided. BB KPIs are used at OAM for BB performance monitoring. In this embodiment, denoting by [symbol] ₘ(BBₛ, AUₗ) an m'th measurement table for BB s of AU l, examples of BB KPIs are provided. BB KPI of BB s of AU l can be one of the following or a combination of more than one of the following. Accordingly, KPI target(s) for a BB can be defined, e.g., using BB KPI threshold(s).

In one example of BB KPIs for beam usage, the following is provided: (i) c₀( [symbol] ₘ(BBₛ, AUₗ): a number of beams within BB s with beam usage 0 in a measurement table [symbol] ₘ(BBₛ, AUₗ) for an AU l. The lower value of c₀( [symbol] ₘ(BBₛ, AUₗ)) for BBₛ, the better performance of BBₛ for AUₗ; (ii) C_{x*}( [symbol] ₘ(BBₛ, AUₗ): a number of beams within BB s with beam usage ≤x* in a measurement report [symbol] ₘ(BBₛ, AUₗ) for an AU l. The lower value of C_{x*}( [symbol] ₘ(BBs, AUₗ)) for BBₛ, the better performance of BBₛ for AUₗ·C_{x*}( [symbol] ₘ(BBₛ, AUₗ))≙

$${\sum }_{x = 0}^{{x}^{*}} {c}_{x} ( {ℳ}_{m} ( B {B}_{s} , {AU}_{l} ) ) ;$$

(iii) [symbol] ₘ(BBₛ,AUₗ): variance of beam usage. The lower value of [symbol] ₘ(BBₛ,AUₗ) for BBₛ, the better performance of BBₛ for

$$A {U}_{l} {Mean}_{usage , {ℳ}_{m} ( B {B}_{s} A {U}_{l} )} {=}^{Δ} \frac{1}{{N}_{B , s}} {\sum }_{i = 1}^{{N}_{B , s}} {usage}_{i} ( {ℳ}_{m} ( B {B}_{s} , {AU}_{l} ) ) .$$

$${Var}_{u sage , {ℳ}_{m} ( B {B}_{s} , {AU}_{l} )} {=}^{Δ} \frac{1}{{N}_{B , s}} {\sum }_{i = 1}^{{N}_{B , s}} {( {usage}_{i} ( {ℳ}_{m} ( B {B}_{s} , {AU}_{l} ) ) - {Mean}_{usage , {ℳ}_{m} ( B {B}_{s} , {AU}_{l} )} )}^{2} ;$$

and (iv) [symbol] ₘ(BBₛ,AUₗ): Mean absolute deviation of beam usage. The lower value of [symbol] ₘ(BBₛ,AUₗ) for BBₛ, the better performance of BBₛ for AUₗ.

$${MAD}_{usage , {ℳ}_{m} ( {BB}_{s} , {AU}_{l} )} {=}^{Δ} \frac{1}{{N}_{B , s}} {\sum }_{i = 1}^{{N}_{B , s}} \vert {usage}_{i} ( {ℳ}_{m} ( B {B}_{s} , {AU}_{l} ) ) - {Mean}_{usage , {ℳ}_{m} ( B {B}_{s} , {AU}_{l} )} \vert .$$

In one embodiment, BB KPIs for beam RSRP are provided. In such an embodiment, the following can be provided: (i) Meanᵣₛᵣₚ( [symbol] ₘ(BBₛ, AUₗ)): mean beam RSRP of BB s in a measurement table [symbol] ₘ(BBₛ, AUₗ) for an AU l. The higher a value of Meanᵣₛᵣₚ ( [symbol] ₘ(BBₛ, AUₗ)) for BBₛ, the better performance of BBₛ for AUₗ.

$${Mean}_{rsrp , {ℳ}_{m} ( B {B}_{s} , {AU}_{l} )} {=}^{Δ} \frac{1}{{N}_{B , s}} {\sum }_{i = 1}^{{N}_{B , s}} {\overline{rsrp}}_{i} ( {ℳ}_{m} ( {BB}_{s} , {AU}_{l} ) )$$

and (ii) RSRP (p %, [symbol] ₘ(BBₛ, AUₗ)): p-percentile beam RSRP of BB s in a measurement table [symbol] ₘ(BBₛ, AUₗ) for an AU l. The higher a value of RSRP (p %, [symbol] ₘ(BBₛ, AUₗ) for BBₛ, the better performance of BBₛ for AUₗ.

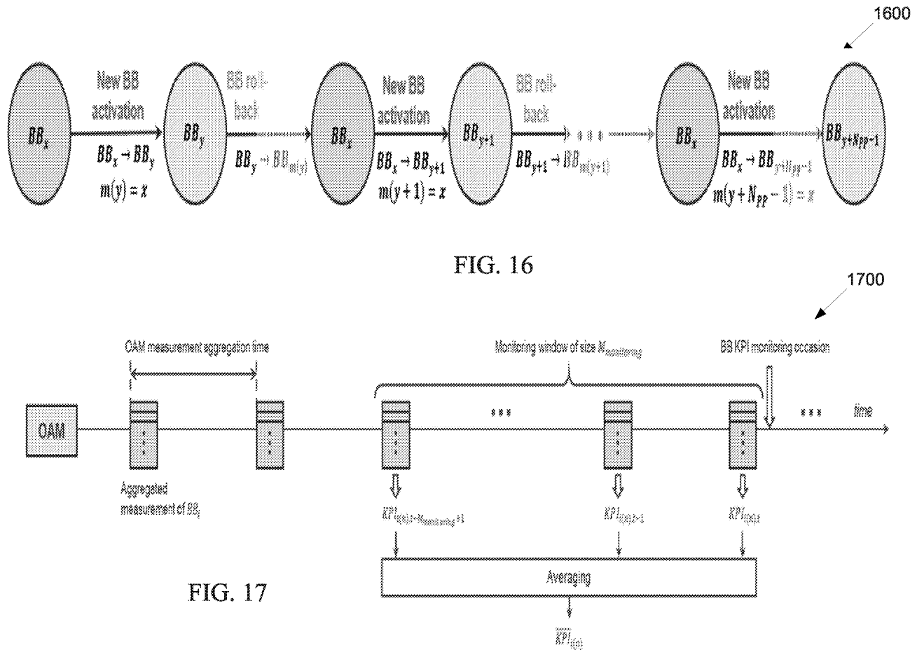

In one embodiment, AU-specific BB performance monitoring is provided. The following notations and definitions are used throughout the present disclosure: (i) global BB indexing for an AU: (1) each BB is denoted as BBₓ, where x is the global BB index of the BB, (2) the global BB index of the latest designed/generated BB is denoted as L, (3) the global BB index of the currently active BB is denoted as i(n), where n is a last occasion at which a BB update has been performed for the AU, and (4) the global BB index of the previously active BB is denoted as i(n−1); (ii) mother BB of BBₓ (denoted as m(x)): the baseline BB based on which the BBₓ is designed and activated in a new BB activation; and (iii) ping pong event with a baseline BB BBₓ (denoted as PPₓ): an event where the actions of “new BB activation from BBₓ” and “BB roll-back to BBₓ” alternate N_{PP} times sequentially, as illustrated in FIG. 16.

FIG. 16 illustrates an example of ping pong event in AU-specific BB performance monitoring 1600 according to various embodiments of the present disclosure. An embodiment of the ping pong event in AU-specific BB performance monitoring 1600 shown in FIG. 16 is for illustration only.

FIG. 17 illustrates an example of BB KPI storage and monitoring at OAM 1700 according to various embodiments of the present disclosure. An embodiment of the BB KPI storage and monitoring at OAM 1700 shown in FIG. 17 is for illustration only.

In one embodiment, BB KPI storage and monitoring at OAM are provided. The following are stored in OAM log server and monitored by OAM, as illustrated in FIG. 17: (i) BB KPI(s) of last M_{monitoring} aggregated measurements associated with the last activated initial BB BB₀ and their average value, K̅P̅I̅₀; (ii) BB KPI(s) of last M_{monitoring} aggregated measurements associated with the previously activated AU-specific BBᵢ₍ₙ₋₁₎ and their average value, K̅P̅I̅ᵢ₍ₙ₋₁₎; and (iii) BB KPI(s) of the latest M_{monitoring} aggregated measurements associated with the currently active AU-specific BBᵢ₍ₙ₎ and their average value, K̅P̅I̅ᵢ₍ₙ₎.

In KPI monitoring cases as illustrated in the present disclosure, the KPI averaging can be done using, e.g., linear averaging, weighted averaging, geometrical averaging, or any other mathematical averaging method.

At each BB KPI monitoring occasion, one of the following cases occurs based on outcome of KPI monitoring at that occasion. Condition(s) for each case and a sequence of actions which are triggered by each case are described as follows.

In one example of no BB change: (i) conditions: K̅P̅I̅ᵢ₍ₙ₎ meets BB KPI target and (ii) actions: none.

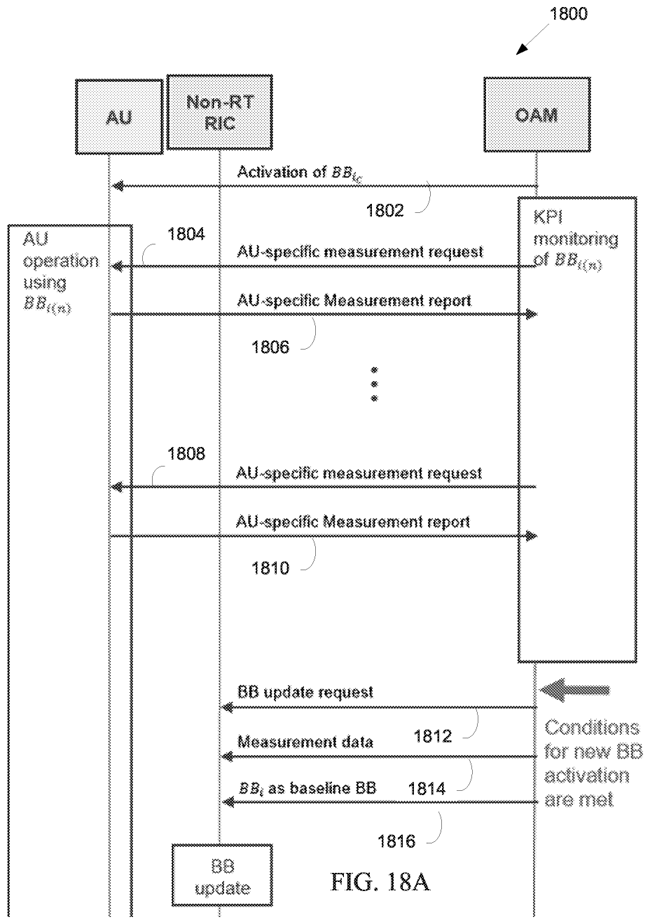

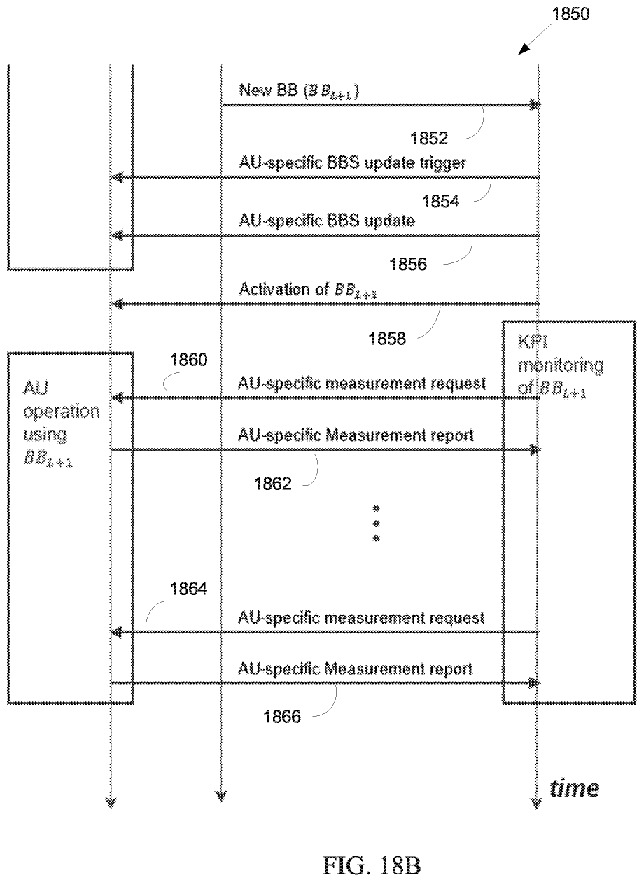

FIG. 18A illustrates an example of BB activation BBᵢ₍ₙ₎→BB_{L+1} 1800 according to various embodiments of the present disclosure. An embodiment of the BB activation BBᵢ₍ₙ₎→BB_{L+1} 1800 shown in FIG. 18A is for illustration only.

FIG. 18B illustrates an example of BB activation BBᵢ₍ₙ₎→BB_{L+1} 1850 according to various embodiments of the present disclosure. An embodiment of the BB activation BBᵢ₍ₙ₎→BB_{L+1} 1850 shown in FIG. 18B is for illustration only. FIG. 18A and FIG. 18B are connected and the step 1816 in FIG. 18A is followed by the step 1852 as illustrated in FIG. 18B.

As illustrated in FIG. 18A and FIG. 18B, in step 1802, the OAM sends an activation of BB and sends an AU-specific measurement report to an AU in step 1804. In step 1806, the OAM receives an AU-specific measurement report from the AU in response to transmitting the request. In step 1808, the OAM sends an AU-specific measurement request to the AU and receives, in step 1810, an AU-specific measurement report from the AU. The OAM sends a BB update request in step 1812, sends measurement data in step 1814, and sends BB as baseline BB in step 1814 to a non-RT RIC, respectively. In response to sending the update request, the measurement data, and the BB, the OAM receives a new BB from the non-RT RIC in step 1852. In step 1854, the OAM sends AU-specific BBS update trigger and AU-specific BBS update in step 1856 to the AU. In addition, the OAM sends activation BB to the AU in step 1858. In step 1860, the OAM sends AU-specific measurement request to the AU and receives AU-specific measurement report form the AU in step 1862. These operations are continued in step 1864 and 1866 between the OAM and the AU.

In one example of new BB activation, BBᵢ₍ₙ₎→BB_{L+1}, which is illustrated in FIG. 18A and FIG. 18B: (i) conditions: if both of the following conditions are met, a new BB activation is triggered: (1) K̅P̅I̅ᵢ₍ₙ₎ does not meet BB KPI target, e.g., based on a target threshold and (2) K̅P̅I̅ᵢ₍ₙ₎ is better than K̅P̅I̅ᵢ₍ₙ₋₁₎; and (ii) actions: (1) SW and trace management triggers AU-specific BB (re-)optimization, and instructs transfer of BBᵢ as a baseline BB from OAM file manager to non-RT RIC, (2) non-RT RIC designs a new BB and transfers it to OAM file server, (3) SW and trace management instructs transfer of the new BB as BB_{L+1} to AU, (4) new BB activation: SW and trace management activates BB_{L+1} for AU, (5) set i(n+1) as i(n+1):=L+1, (6) increment n i.e., n:=n+1, and (7) increment L i.e., L:=L+1.

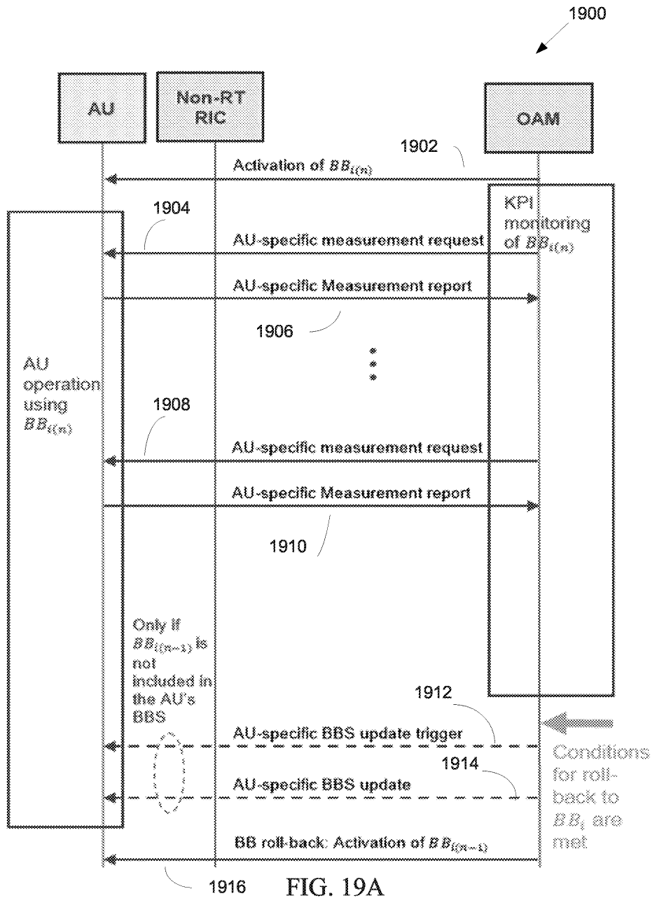

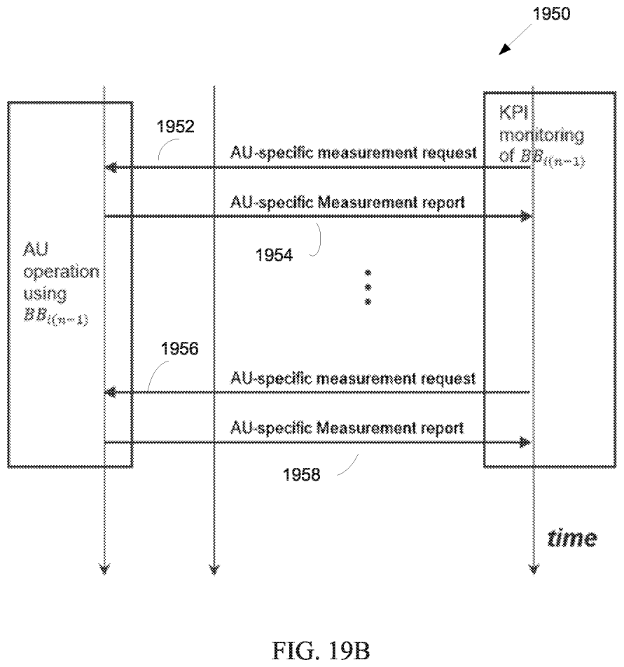

FIG. 19A illustrates an example of single-step BB roll-back BBᵢ₍ₙ₎→BBᵢ₍ₙ₋₁₎ 1900 according to various embodiments of the present disclosure. An embodiment of the single-step BB roll-back BBᵢ₍ₙ₎→BBᵢ₍ₙ₋₁₎ 1900 shown in FIG. 19A is for illustration only.

FIG. 19B illustrates an example of single-step BB roll-back BBᵢ₍ₙ₎→BBᵢ₍ₙ₋₁₎ 1950 according to various embodiments of the present disclosure. An embodiment of the single-step BB roll-back BBᵢ₍ₙ₎→BBᵢ₍ₙ₋₁₎ 1950 shown in FIG. 19B is for illustration only. FIG. 19A and FIG. 19B are connected and the step 1916 in FIG. 19A is followed by the step 1952 as illustrated in FIG. 19B.

As illustrated in FIG. 19A and FIG. 19B, in step 1902, the OAM sends an activation of BB and sends an AU-specific measurement report to an AU in step 1904. In step 1906, the OAM receives an AU-specific measurement report from the AU in response to transmitting the request. In step 1908, the OAM sends an AU-specific measurement request to the AU and receives, in step 1910, an AU-specific measurement report from the AU. The OAM sends an AU-specific BBS update trigger in step 1912, sends AU specific BBS update in step 1914, and sends BB roll-back (activation of BB) in step 1914 to the AU, respectively. In step 1952, the OAM sends AU-specific measurement request to the AU and receives AU-specific measurement repot from the AU in step 1954 in response to sending the measurement request. These operations are continued in step 1956 and 1958 between the OAM and the AU.

In one example of single-step BB roll-back: BBᵢ₍ₙ₎→BBᵢ₍ₙ₋₁₎, which is illustrated in FIG. 19A and FIG. 19B: (i) conditions: if both of the following conditions are met, a BB roll-back to an AU-specific BB is triggered: (1) K̅P̅I̅ᵢ₍ₙ₎ does not meet BB KPI target, e.g., based on a target threshold and (2) K̅P̅I̅ᵢ₍ₙ₎ is worse than K̅P̅I̅ᵢ₍ₙ₋₁₎ and (ii) actions: (1) if BBᵢ₍ₙ₋₁₎ is not included in the AU's BBS, SW and trace management instructs transfer of BBᵢ₍ₙ₋₁₎ to AU, (2) BB roll-back: SW and trace management activates BBᵢ₍ₙ₋₁₎ for AU, (3) set i(n+1) as i(n+1):=i(n−1), and (4) increment n i.e., n:=n+1.

In one embodiment of two-step BB roll-back (if applicable), BBᵢ₍ₙ₎→BBₘ₍ₘ₍ᵢ₍ₙ₎₎₎: (i) conditions: the following events occur sequentially for any M≤N_{R}, where N_{R}≥0 is a design parameter: (1) 1^{st} ping pong event: PPᵢ₍ₙ₎, (2) 1^{st} two-step roll-back: BBᵢ₍ₙ₎→BBₘ₍ₘ₍ᵢ₍ₙ₎₎₎, (3) 2^{nd} ping pong event: PPᵢ₍ₙ₎, (4) 2^{nd} two-step roll-back: BBᵢ₍ₙ₎→BBₘ₍ₘ₍ᵢ₍ₙ₎₎₎, . . . and (5) M^{th} ping pong event: PPᵢ₍ₙ₎; and (ii) actions: (1) if BBₘ₍ₘ₍ᵢ₍ₙ₎₎₎ is not included in the AU's BBS, SW and trace management instructs transfer of BBₘ₍ₘ₍ᵢ₍ₙ₎₎₎ to AU, (2) BB roll-back: SW and trace management activates BBₘ₍ₘ₍ᵢ₍ₙ₎₎₎ for AU, (3) set i(n+1) as i(n+1):=m(m(i(n))), and (4) increment n i.e., n:=n+1.

In one example of roll-back to an initial BB, BBᵢ₍ₙ₎→BB₀: (i) conditions: either of the following conditions: (1) the following events occur sequentially, where N_{R}≥0 is a design parameter: (a) 1^{st} ping pong event: PPᵢ₍ₙ₎, (b) 1^{st} two-step roll-back: BBᵢ₍ₙ₎→BBₘ₍ₘ₍ᵢ₍ₙ₎₎₎, (c) 2^{nd} ping pong event: PPᵢ₍ₙ₎, (d) 2^{nd} two-step roll-back: BBᵢ₍ₙ₎→BBₘ₍ₘ₍ᵢ₍ₙ₎₎₎, . . . and (e) (N_{R}+1)^{th} ping pong event: PPᵢ₍ₙ₎ and (2) BB design algorithm update; and (ii) actions: (1) if BB₀ is not included in the AU's BBₛ, SW and trace management instructs transfer of BB₀ to AU, (2) BB roll-back: SW and trace management activates BB₀ for AU, (3) set i(n+1) as i(n+1):=0, and (4) increment n i.e., n:=n+1.

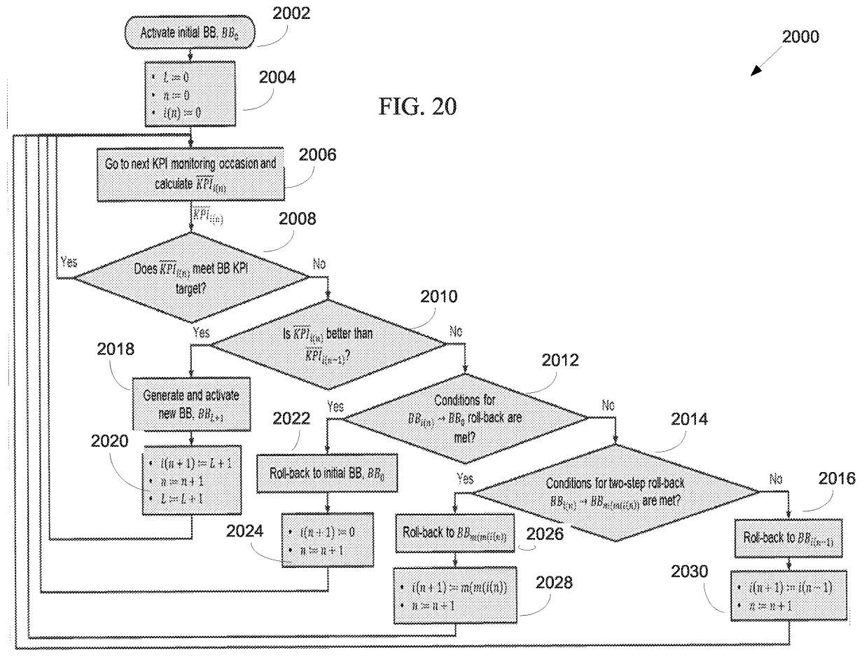

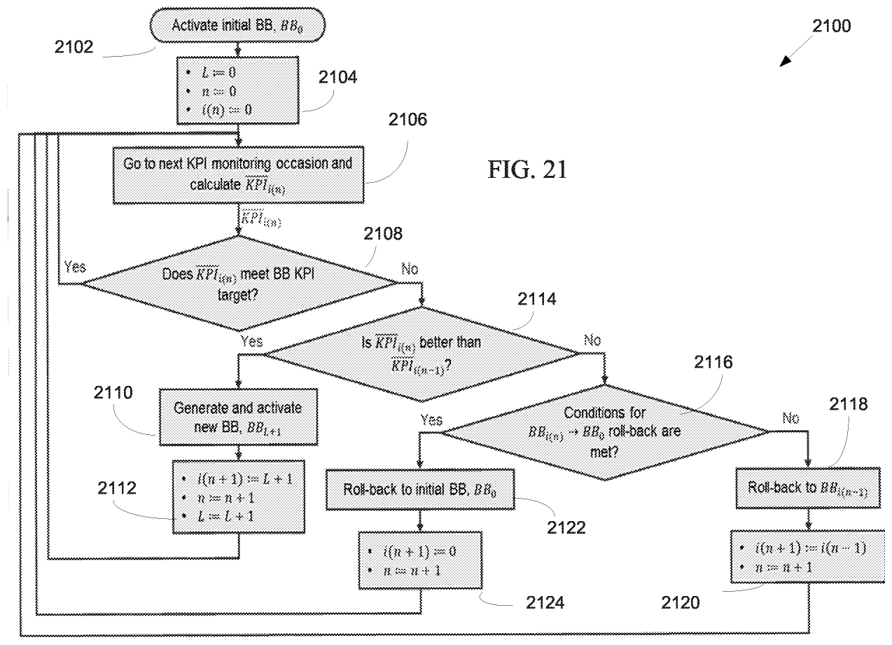

FIG. 20 and FIG. 21 provide example flow charts for AU-specific BB performance monitoring procedure as described above for cases of N_{R}≥1 and N_{R}=0, respectively.

FIG. 20 illustrates a flowchart of method 2000 for AU-specific BB performance monitoring N_{R}≥1 according to various embodiments of the present disclosure. The method 2000 may be performed by a base station (e.g., 101-103 as illustrated in FIG. 1). An embodiment of the method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

As illustrated in FIG. 20, in step 2002, an initial BB is activated. In step 2004, some parameters are set to zero values. In step 2006, identify the KPI monitoring occasion and calculate average of KPI. In step 2008, whether the average KPI is met with BB KPI target is determined. In step 2008, if it is yes, step 2006 is performed, otherwise, in step 2010, whether the average KPI is better than previous average KPI is determined. In step 2010, if it is yes, new BB is generated and activated in step 2018 and set parameters, configured in step 2004, with new values, and performs the step 2006. In step 2010, if it is no, in step 2012, whether the conditions (e.g., roll back) are met is determined. In step 2012, if it is yes, perform steps 2022 (e.g., roll back to initial BB) and 2024 (e.g., set to new values for the parameter set in step 2004), and go to step 2006. In step 2012, if it is no, in step 2014, whether the conditions for two-step roll back is met is determined. In step 2014, if it is yes, in step 2026, performs the roll back to the BB and sets with new values in step 2028. In step 2014, if it is no, performs step 2016 and 2030.

FIG. 21 illustrates a flowchart of method 2100 for AU-specific BB performance monitoring N_{R}=0 according to various embodiments of the present disclosure. The method 2100 may be performed by a base station (e.g., 101-103 as illustrated in FIG. 1). An embodiment of the method 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

As illustrated in FIG. 21, in step 2102, an initial BB is activated. In step 2104, some parameters are set to zero values. In step 2106, identify the KPI monitoring occasion and calculate average of KPI. In step 2108, whether the average KPI is met with BB KPI target is determined. In step 2108, if it is yes, step 2106 is performed, otherwise, in step 2114, whether the average KPI is better than previous average KPI is determined. In step 2114, if it is yes, new BB is generated and activated in step 2110 and set parameters in step 2112, configured in step 2104, with new values, and performs the step 2106. In step 2114, if it is no, in step 2116, whether the conditions (e.g., roll back) are met is determined. In step 2116, if it is yes, perform steps 2122 (e.g., roll back to initial BB) and 2124 (e.g., set to new values for the parameter set in step 2104), and go to step 2106. In step 2116, if it is no, performs the roll back to the BB in step 2118 and sets with new values in step 2120.

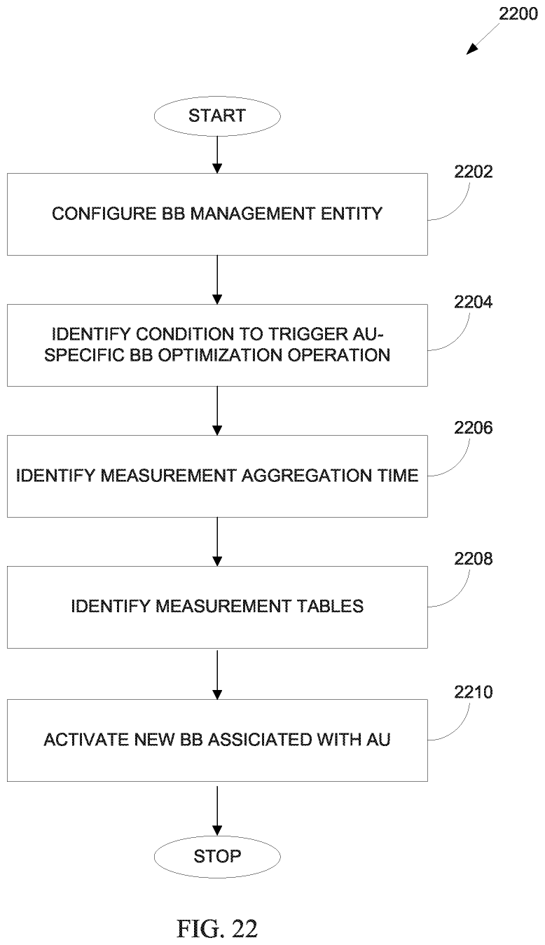

FIG. 22 illustrates a flowchart of method 2200 of a base station for a life cycle management for a beambook design according to various embodiments of the present disclosure. The method 2200 may be performed by a network entity (e.g., base station, 101-103 as illustrated in FIG. 1). An embodiment of the method 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

As illustrated in FIG. 22, the method 2200 begins at step 2202. In step 2202, the BS configures a BB management entity to monitor performance of a BB configured to an AU. Subsequently, in step 2204, the BS identifies a condition to trigger an AU-specific BB optimization operation for activating a new BB associated with the AU. Subsequently, in step 2206, the BS identifies, based on the condition, a measurement aggregation time. Next, in step 2208, the BS identifies, based on the measurement aggregation time, a set of measurement tables each of which includes a set of beam IDs and a number of beam usage counts. Finally, in step 2210, the BS activates, based on the set of measurement table, the new BB associated with the AU.

In one embodiment, the BS maintains the BB without changes, rolls back to a previously activated BB associated with the AU, rolls back to an initial BB, or triggers a new AU-specific BB design and activate the new AU-specific BB.

In one embodiment, the BS enables an OAM entity and an SMO entity communicating each other. In such an embodiment, the OAM entity includes a log server, SW and trace management entity, a file server, and a package management entity that are connected to the AU for generating KPI monitoring results, the KPI including an initial BB, a previously activated AU-specific BB, and a currently active AU-specific BB; and the SMO entity includes a data preparation entity and an AU-specific BB design entity that are connected each other in a non-RT RIC.

In one embodiment, the BS updates and construct a BBS based on an operation of the SW and trace management entity; and transfers the BBS to the AU.

In one embodiment, the BS triggers the non-RT RIC for optimizing or reoptimizing a baseline BB associated with the AU to improve the performance of the BB; and transfers the baseline BB to the non-RT RIC from the file server. In such an embodiment, new BBs associated with the AU are designed and a BB index of the new BB is transferred to the SW and trace management entity, the new BBs comprising initial BBs and BBs associated with the AU; and the baseline BB comprises a latest activated BB associated with the AU.

In one embodiment, the BS activates AU-specific BBs within a BBS after updating AU-specific BBS; and rolls back to previously verified BBs within the BBS.

In such embodiments, the condition is identified based on: an AU measurement report generated during monitoring the performance of the BB, the AU measurement report including at least one of (i) a beam ID and a number of beam usage counts, (ii) an average beam RSRP, or (iii) a time stamp indicating a reception time of the AU measurement report; and BBs corresponding to an AU cluster including a set of AUs.

In such embodiments, the set of AUs in the AU cluster is identified based on attributes of the AU and the attributes of the AU includes a cell size, cell load and traffic characteristics, and an angular scan range.

In one embodiment, the BS activates, based on the condition, the new BB, wherein the condition is satisfied with: an average KPI that does not meet a BB KPI target value based on a target threshold and the average KPI that is higher than a previous average KPI.

In one embodiment, the BS rolls back, based on the condition, to an AU-specific BB, wherein the condition is satisfied with: an average KPI that does not meet a BB KPI target value based on a target threshold and the average KPI that is less than a previous average KPI.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the claims appended. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver; and
a processor operably coupled to the transceiver, the processor configured to:
configure a beambook (BB) management entity to monitor performance of a BB configured to an access unit (AU),
identify a condition to trigger an AU-specific BB optimization operation for activating a new BB associated with the AU,
identify, based on the condition, a measurement aggregation time,
identify, based on the measurement aggregation time, a set of measurement tables each of which includes a set of beam identification (IDs) and a number of beam usage counts, and
activate, based on the set of measurement table, the new BB associated with the AU.

2. The BS of claim 1, wherein the processor is further configured to, based on the monitored performance of the BB, at least one of:
maintain the BB without changes,
roll back to a previously activated BB associated with the AU,
roll back to an initial BB, or
trigger a new AU-specific BB design and activate the new AU-specific BB.

3. The BS of claim 1, wherein:
the processor is further configured to enable an operation, administration, and maintenance (OAM) entity and a service management and orchestration (SMO) entity communicating each other,
the OAM entity includes a log server, software (SW) and trace management entity, a file server, and a package management entity that are connected to the AU for generating key performance index (KPI) monitoring results, the KPI including an initial BB, a previously activated AU-specific BB, and a currently active AU-specific BB, and
the SMO entity includes a data preparation entity and an AU-specific BB design entity that are connected each other in a non-real time radio intelligent controller (non-RT RIC).

4. The BS of claim 3, wherein the package management entity is configured to:
update and construct a BB set (BBS) based on an operation of the SW and trace management entity; and
transfer the BBS to the AU.

5. The BS of claim 3, wherein:
the SW and trace management entity is configured to:
trigger the non-RT RIC for optimizing or reoptimizing a baseline BB associated with the AU to improve the performance of the BB, and
transfer the baseline BB to the non-RT RIC from the file server;
the non-RT RIC is configured to design new BBs associated with the AU and a BB index of the new BB is transferred to the SW and trace management entity, the new BBs comprising initial BBs and BBs associated with the AU; and
the baseline BB comprises a latest activated BB associated with the AU.

6. The BS of claim 5, wherein the SW and trace management entity is further configured to:
activate AU-specific BBs within a BB set (BBS) after updating AU-specific BBS; and
roll back to previously verified BBs within the BBS.

7. The BS of claim 1, wherein the condition is identified based on:
an AU measurement report generated during monitoring the performance of the BB, the AU measurement report including at least one of (i) a beam identifier (ID) and a number of beam usage counts, (ii) an average beam reference signal received power (RSRP), or (iii) a time stamp indicating a reception time of the AU measurement report; and
BBs corresponding to an AU cluster including a set of AUs.

8. The BS of claim 7, wherein:
the set of AUs in the AU cluster is identified based on attributes of the AU; and
the attributes of the AU includes a cell size, cell load and traffic characteristics, and an angular scan range.

9. The BS of claim 1, wherein the processor is further configured to activate, based on the condition, the new BB, the condition being satisfied with:
an average KPI that does not meet a BB KPI target value based on a target threshold; and
the average KPI that is higher than a previous average KPI.

10. The BS of claim 1, wherein the processor is further configured to roll back, based on the condition, to an AU-specific BB, the condition being satisfied with:
an average KPI that does not meet a BB KPI target value based on a target threshold; and
the average KPI that is less than a previous average KPI.

11. A method of a base station (BS) in a wireless communication system, the method comprising:
configuring a beambook (BB) management entity to monitor performance of a BB configured to an access unit (AU);
identifying a condition to trigger an AU-specific BB optimization operation for activating a new BB associated with the AU;
identifying, based on the condition, a measurement aggregation time;
identifying, based on the measurement aggregation time, a set of measurement tables each of which includes a set of beam identification (IDs) and a number of beam usage counts; and
activating, based on the set of measurement table, the new BB associated with the AU.

12. The method of claim 11, further comprising at least one of:
maintaining the BB without changes,
rolling back to a previously activated BB associated with the AU,
rolling back to an initial BB, or
triggering a new AU-specific BB design and activate the new AU-specific BB.

13. The method of claim 11, further comprising enabling an operation, administration, and maintenance (OAM) entity and a service management and orchestration (SMO) entity communicating each other,
wherein:
the OAM entity includes a log server, software (SW) and trace management entity, a file server, and a package management entity that are connected to the AU for generating key performance index (KPI) monitoring results, the KPI including an initial BB, a previously activated AU-specific BB, and a currently active AU-specific BB; and
the SMO entity includes a data preparation entity and an AU-specific BB design entity that are connected each other in a non-real time radio intelligent controller (non-RT RIC).

14. The method of claim 13, further comprising:
updating and construct a BB set (BBS) based on an operation of the SW and trace management entity; and
transferring the BBS to the AU.

15. The method of claim 13, further comprising:
triggering the non-RT RIC for optimizing or reoptimizing a baseline BB associated with the AU to improve the performance of the BB; and
transferring the baseline BB to the non-RT RIC from the file server,
wherein:
new BBs associated with the AU are designed and a BB index of the new BB is transferred to the SW and trace management entity, the new BBs comprising initial BBs and BBs associated with the AU; and
the baseline BB comprises a latest activated BB associated with the AU.

16. The method of claim 15, further comprising:
activating AU-specific BBs within a BB set (BBS) after updating AU-specific BBS; and
rolling back to previously verified BBs within the BBS.

17. The method of claim 11, wherein the condition is identified based on:
an AU measurement report generated during monitoring the performance of the BB, the AU measurement report including at least one of (i) a beam identifier (ID) and a number of beam usage counts, (ii) an average beam reference signal received power (RSRP), or (iii) a time stamp indicating a reception time of the AU measurement report; and
BBs corresponding to an AU cluster including a set of AUs.

18. The method of claim 17, wherein:
the set of AUs in the AU cluster is identified based on attributes of the AU; and
the attributes of the AU includes a cell size, cell load and traffic characteristics, and an angular scan range.

19. The method of claim 11, further comprising activating, based on the condition, the new BB, wherein the condition is satisfied with:
an average KPI that does not meet a BB KPI target value based on a target threshold; and
the average KPI that is higher than a previous average KPI.

20. The method of claim 11, further comprising rolling back, based on the condition, to an AU-specific BB, wherein the condition is satisfied with:
an average KPI that does not meet a BB KPI target value based on a target threshold; and
the average KPI that is less than a previous average KPI.
